(19) United States
(12) Patent Application Publication
(10) Pub. No.: US 2005/0225553 A1
(43) Pub. Date: Oct. 13, 2005

(54) Hybrid model sprite generator (HMSG) and a method for generating sprite of the same

(76) Inventor: Cheng-Jan Chi, Taipei Hsien (TW)

Correspondence Address: RABIN & BERDO, P.C.;Suite 500, 1101 14th Street, N.W., Washington, DC, 20005, US

(21) Appl. No.: 11/101,418

(22) Filed: Apr. 8, 2005

(30) Foreign Application Priority Data
Apr. 9, 2004 (TW) 93109934

(51) Int. Cl. G06T 13/00; G06T 15/70

(52) U.S. Cl. 345/474

(57) ABSTRACT

A hybrid model Sprite generator (HMSG) comprising a hybrid global motion estimation (GME) unit and a fast image warping unit is provided. The hybrid GME unit maps a reliable image region and a prior Sprite, and it has an adaptive switch which is utilized to choose a proper motion parameter output. The fast image warping unit uses nearest neighbor (NN) kernel to pose the reliable image region on the prior Sprite.

### BACKGROUND OF THE INVENTION

(1) Field of the Invention

This invention relates to a hybrid model Sprite generator (HPSG), and more particularly to an HPSG with a simplified interpolation kernel and a hybrid model global motion estimation (GME) to improve image quality without increasing the computation time.

(2) Description of the Prior Art

Traditional image processing method deals with series of images by regarding the frames without division to generate compressed image data. Some stilled divisions of the images, such as a dull background, are repeatedly compressed to result a waste of data storage and meet some trouble when it is applied to the very low bit-rate environment. Therefore, MPEG-4 standard is defined in the committee by using object-based compressing method for the purpose of various multimedia applications.

For processing such an image-based compressing method, a newly defined Sprite is included in the MPEG-4 standard. A Sprite is an image composed of pixels belonging to the background objects of a video segment. The Sprite removes the repeated portions within the background objects to reduce the data amount for an effective video transmission.

Basically, as shown in FIG. 1, the Sprite generation algorithm comprises three steps: a pre-processing step 1, a global motion estimation (GME) step 2, and an image warping and blending step 3. The pre-processing step 1 is utilized to deal with the sharp edges of the background objects to prevent the wrong-estimation in the following GME step 2. The GME step 2 is utilized to create some estimated parameters according to the background objects. The warping and blending step 3 is utilized to warp the background objects according to the estimated parameters and blend the background objects to result a Sprite.

FIG. 2 shows the Sprite generator 100 in MPEG-4 optimized model (MPEG-4 OM) presented in the 56th MPEG conference. The Sprite generator 100 has an image region division unit 110, a GME unit 120, a segmentation unit 130, a frame memory 140, a warping unit 150, and a blending unit 160.

The image region division unit 110 uses a reliable mask to define an edge region between the reliable image region and the undefined image region in the video object plane (VOP), which is also named as unreliable image region. It should be noted that only the reliable image region is engaged in the following GME kernel.

The frame memory 140 stores a prior Sprite, which is organized from the reliable image regions of all the VOPs happening before the present estimation kernel.

The GME unit 120 applies a GME kernel, which uses a parametric geometrical model to represent the change of viewing angle and camera position, to access some motion parameters by matching the pixels of the present reliable image region and the prior Sprite. Thus, the motivation difference of the present reliable image region with respect to the prior Sprite is defined.

The segmentation unit 130 is utilized to remove the mixed undefined image region and unreliable image region from the reliable image region to improve the accuracy of the Sprite.

The warping unit 150 is utilized to warp the reliable image region by using the parameters accessed by the GME unit 120, and it also searches the location of the reliable image region on the prior Sprite by using bilinear interpolation kernel to update the Sprite.

As mentioned, only the reliable image region is used and warped to update the sprite. However, the unreliable image region may affect the accuracy of the resulted updated Sprite in some cases. Thus, the blending unit 160 is used to recognize whether the pixels in the update Sprite respected to the unreliable image region are replaced by the reliable image region. If not, the blending unit 160 may divide the unreliable image region from the VOP and blend it on the updated Sprite.

Moreover, the GME unit 120 disclosed by Yan Lu has a three-tier GME architecture, which is shown in FIG. 3. The reference image as shown is an image formed by warping the Sprite stored in the frame memory 140. The current image is the reliable image region comes from the image division unit 110. The reference image and the current image are applied with some down-sampling steps before they are matched in the following GME step, so as to reduce the number of pixels needed to be matched.

It is noted that in the three-tier GME architecture as shown, the reference image and the current image are roughest down-sampled at the first tier a. The down-sampled reference image and current image at the first tier a are firstly input to a translation estimation unit 122, which matches the relative positions of the pixels on the two images to create some translation parameter n1. The translation estimation unit 122 processes with a rough estimation kernel to prevent local minimum within the reliable image region from resulting the magnification of errors in the following GME steps and also speed up the following steps.

In the first tier a, a gradient descent unit 124 receives the translation parameter n1 from the translation estimation unit 122 and matches the pixels of the reference image and the current image thereby, so as to output some motion parameter n2. The output motion parameters n2 needs to be check to make sure that they are converge before entering the second tier b. If the resulted parameters n2 are not converge, the calculation process in the first tier a needs to be repeated.

The second tier b and the third tier c processes with similar calculation kernels with respect to the first tier a. The gradient descent units 124 of the three tiers are utilized with identical transformation model but different accuracy. The second tier b is used to fine-tune the motion parameters n2 comes from the first tier a, and the third tier c is used to fine-tune the motion parameter n3 comes from the second tier b. In addition, the sampled image input to the second tier b is more precise than that input to the first tier a, and the sampled image input to the third tier c is more precise than that input to the second tier b. Therefore, the output motion parameter n4 of the third tier c is definitely more accurate than the motion parameter n2 or n3.

The gradient descent units 124 may be processed with affine transformation model or perspective transformation model according to the need of visual quality. It is understood that a transformation model with higher order, such as the perspective transformation model, provides a better visual quality but an increasing data amount and a consumption of calculation and transmission time. A transformation model with lower order, such as the affine transformation model, may result a poor Sprite to decrease visual quality. Thus, it seems impossible to improve the visual quality and the calculation speed at the same time.

Accordingly, how to improve the visual quality without sacrificing the calculation speed has become an important topic in the image compressing industry.

### SUMMARY OF THE INVENTION

A main object of the present invention is to provide a hybrid model Sprite generator, which may reduce the calculation speed and upgrade visual quality at the same time.

The hybrid model Sprite generator comprises an image region division unit, a frame memory, a hybrid model global motion estimation (GME) unit, and a fast image warping unit. The image region division unit is utilized for removing foreground objects within a video object plane (VOP) to provide background objects. The frame memory is utilized for storing a prior Sprite.

The hybrid model global motion estimation (GME) unit includes a first estimation subunit with a preset order, a second estimation subunit with a higher order, and an adaptive switch. The first estimation subunit with a preset order is utilized to generate a first parameter set to estimate the motivation and deformation of the background objects with respect to the prior Sprite. The second estimation subunit with a higher order is utilized to tune the first parameter set by matching the background objects to the prior Sprite to generate a second parameter set. The adaptive switch is utilized to selectably output the first parameter set or the second parameter set.

The fast image warping unit is utilized to warp the background objects according to the output of the adaptive switch and recognize the location of the warped objects on the prior Sprite by using nearest neighborhood interpolation method to update the Sprite.

The method for generating Sprite in accordance with the present invention comprises the steps of: providing an VOP and a prior Sprite; removing foreground objects of the VOP to provide the background objects thereof; estimating the motivation and deformation of the background object with respect to the prior Sprite by using the first estimation model to generate a first parameter set; tuning the first parameter set through matching the background objects and the prior Sprite by using a second estimation model to generate a second parameter set; warping the background object according to the first parameter set or the second parameter set to match the prior Sprite; and recognizing the location of the warped background object with respect to the prior Sprite by using nearest neighborhood interpolation to update Sprite.

### BRIEF DESCRIPTION OF THE DRAWINGS

The present invention will now be specified with reference to its preferred embodiment illustrated in the drawings, in which:

FIG. 1 is a flow-chart of a typical Sprite generating algorithm;

FIG. 2 shows the Sprite generator disclosed in the 56′ MPEG-4 conference 2001 by Yan Lu;

FIG. 3 shows the architecture of the three-tier global motion estimation unit disclosed in the Sprite generator of FIG. 2;

FIGS. 4A and B are diagrams illustratingtime consuming percentage of the steps to generate Sprite;

FIG. 5 shows a schematic view of a preferred embodiment of the hybrid model Sprite generator in the present invention;

FIG. 6 shows a schematic view of the architecture of the hybrid model global motion estimation unit in FIG. 5;

FIG. 7 shows a schematic view of the typical 3-step search method;

FIG. 8 shows the image variation of conventional affine transformation;

FIG. 9 shows the image variation of conventional perspective transformation;

FIG. 10 is a flow-chart illustrating the operating process of the adaptive switch according to the prevent invention;

FIG. 11 shows a schematic view of the bipolar interpolation method and the nearest neighborhood interpolation method;

FIG. 12 shows a diagram illustrating the recorded strength error of the pixels on the Sprite when the bipolar interpolation method or the nearest neighborhood interpolation method is used;

FIG. 13 shows a diagram illustrating the calculation time to generate Sprite when different global motion estimation models and interpolation methods are used.

FIG. 14 shows a flow-chart of a preferred embodiment of the Sprite generating method in the present invention;

FIG. 15 shows a diagram illustrating the wasting time to generate Sprite by using the Sprite generator in the present invention or the Sprite generator shown in FIG. 2;

FIG. 16 shows a diagram illustrating the data amount generate by the Sprite generator in the present invention or the Sprite generator shown in FIG. 2.

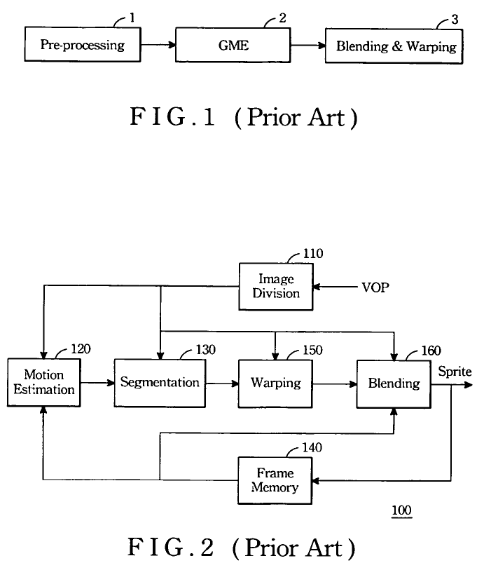

### DESCRIPTION OF THE PREFERRED EMBODIMENTS

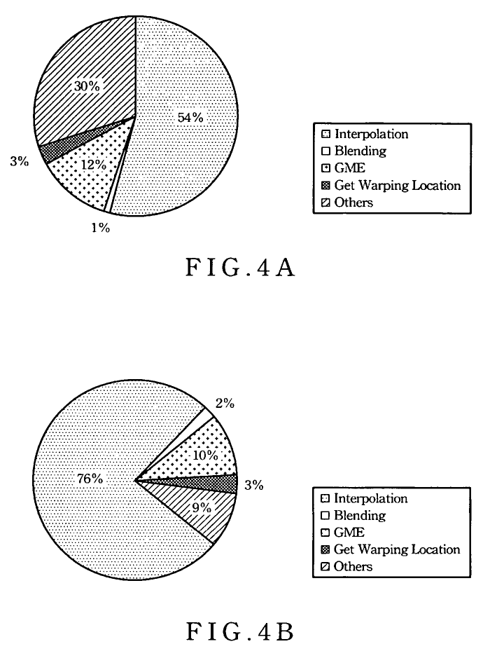

FIGS. 4A and 4B show the percentage of time spent in the steps for generating Sprite as the MPEG-4 OM Sprite generator shown in FIG. 2 is used. FIG. 4A shows the case as the Affine transformation model is used to proceed global motion estimation (GME) step, and FIG. 4B shows the case as the perspective transformation model is used, respectively. As shown, the GME step spends only 10% the whole consumption time. In contrast, the Sprite generator spends more than haft the whole consumption time on performing bilinear interpolation to warp the images. As a result, it is understood that the calculation speed of the Sprite generator is dominated by the step of bilinear interpolation.

Accordingly, the hybrid model Sprite generator in the present invention uses nearest neighborhood (NN) interpolation in replace of the bilinear interpolation for increasing the calculation speed.

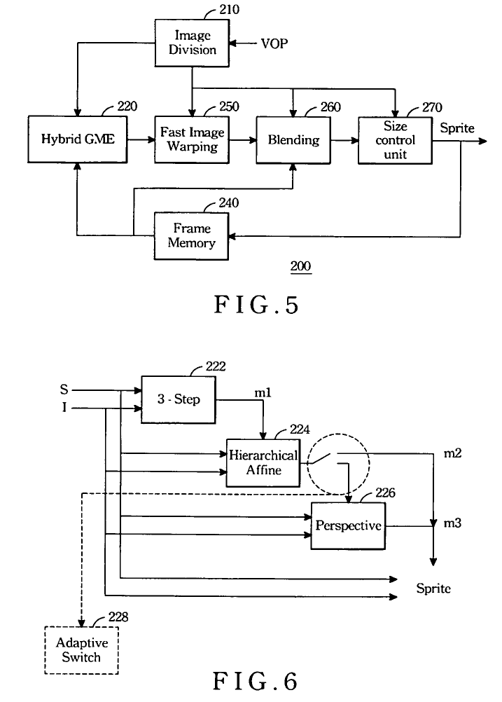

FIG. 5 shows a hybrid model Sprite generator 200 in accordance with the present invention. The hybrid model Sprite generator 200 comprises an image region division unit 210, a frame memory unit 240, a hybrid global motion estimation (GME) unit 230, a fast image warping unit 250, a blending unit 260, and a size control unit 270.

The image region division unit 210 is utilized for removing foreground objects within a video object plane (VOP) to output background objects. The frame memory 240 is utilized for storing a prior Sprite, which is composed of all the prior background objects existed within the VOP. The hybrid model GME unit 230 is utilized for matching the pixels on the background objects and the related pixels on the prior Sprite to access some motion parameters representing the motivation and deformation of the background objects with respect to the prior Sprite.

Fast image warping unit 250 is utilized to warp the background object according to the parameters output from the hybrid model GME unit 230. In addition, the fast image warping unit also recognizes the location of the warped background object with respect to the prior Sprite by using nearest neighborhood interpolation method to update the Sprite. The blending unit 260 accesses the updated Sprite from the fast image warping unit 250 and fulfills the updated Sprite by using part of the foreground objects of the VOP divided by the image region division unit 210 to improve the Sprite.

The size control unit 270 checks the size of the resulted background object after executing the nearest neighborhood interpolation method and the prior Sprite. As the background object needs a magnification over a preset fraction to match the prior Sprite, the size control unit 270 may announce the hybrid model GME unit 220 to reset. That is, as the updated Sprite shows an unreasonable magnification, the size control unit 270 may request the hybrid model GME unit 220 repeat the motion estimation process to produce a new reasonable Sprite. In addition, the size control unit 270 may also check the motion parameters form the hybrid model GME unit 220. As the motion parameters showing abnormal changes, the size control unit 270 announces the hybrid model GME unit 220 to reset.

As shown in FIG. 6, the hybrid model GME 220 in the Sprite generator 200 shown in FIG. 5 comprises a translation estimation subunit 222, a hierarchical affine transformation subunit 224, a perspective transformation subunit 226, and an adaptive switch 228.

The GME uses gradient descent process to estimate the motion parameters of the background object through comparing the respected pixels on the background object I and the prior Sprite S. For proceeding the gradient descent process, the translation estimation subunit 222 is utilized to do some rough translation estimation to make sure the starting data of the gradient descent process is converge, so as to prevent the local minimum on the background object from magnifying the error of the global motion estimation result and to speed up the following estimation steps.

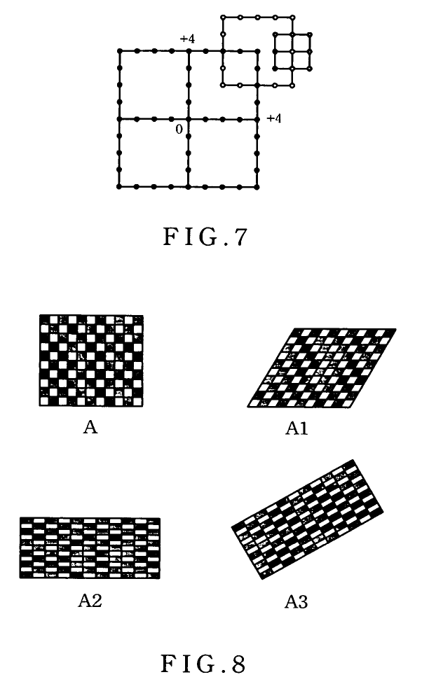

The translation estimation subunit 222 compares the location of the pixels of the background object and the location of the respected pixels on the prior Sprite to generate at least a translation parameter m1. As a preferred embodiment shown in FIG. 7, the translation estimation subunit 222 may adopt the so-called three-step searching method. For a given pixel on the background object, the first step of the three-step search method recognizes the values of an estimated pixel and the surrounded 8 pixels in a plane with 9×9 pixels on the Sprite centered at the estimated pixel, and identify the pixel with the value closest to the value of the given pixel. In the second step, check the values of the 9 pixels in the plane with 5×5 pixels centered at the pixel identified in the first step. In the third step, check the values of the 9 pixels in the plane with 3×3 pixels centered at the pixel identified in the second step. Through the three-step searching method mentioned above, the translation parameter is generated.

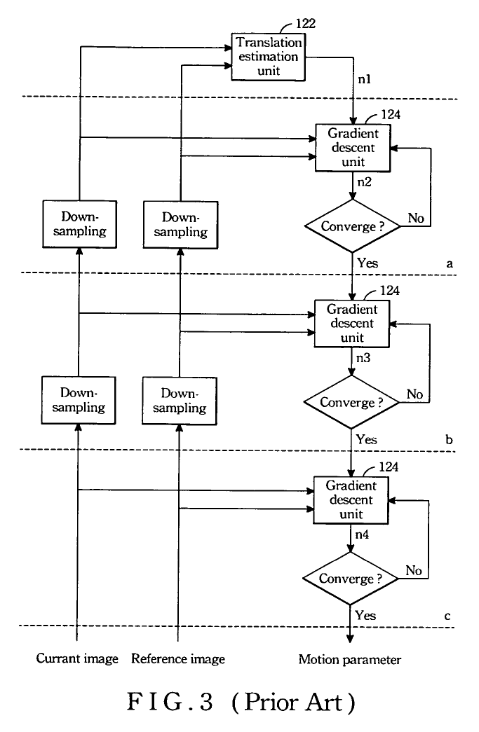

The hierarchical affine transformation subunit 224 shows an architecture similar to the three-tier global motion estimation unit in FIG. 3, but with the gradient descent unit using affine transformation model. The affine transformation model tunes the translation parameter m1 by comparing the coordinate of the pixels on the background object and the coordinate of the respected pixels on the prior Sprite to generate a first parameter set m2 including at least a scale parameter, a shear parameter, and a rotation parameter. For a better understanding of the three types of parameters, take a square object A shown in FIG. 8 for example, after the affine transformation, which represents the effect similar to the parallel plane projection, the square object A is turned into rhombus object A1 (shearing transformation is applied), rectangular object A2 (scaling transformation is applied), or an object A3 showing rotational deformation.

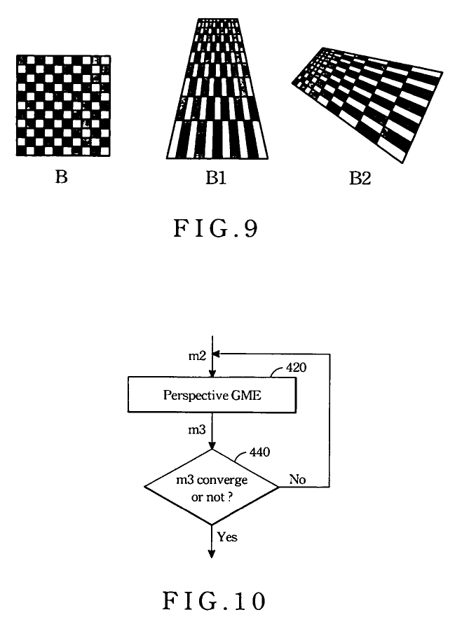

The perspective transformation subunit 226 is utilized to compare the coordinate spaces of the pixels of the background object and the coordinate of the prior Sprite, so as to tune the first parameter set m2 generated by the hierarchical affine transformation subunit 224 and generate a second parameter set m3 including at least a tuned scale parameter, a tuned shear parameter, a tuned rotation parameter, a tuned translation parameter, and a perspective parameter representing depth variation. The perspective transformation model not only represents all the transformation types the affine transformation model possesses, but also represents the variation of depth. Take a square object B shown in FIG. 9 for example, after the perspective transformation, the square is object B is turned into the objects B1, B2 showing the feeling from near to far.

The adaptive switch 228 is connected to the rear end of the hierarchical affine transformation subunit 224 to decide whether the first parameter set m2 is input to the perspective transformation subunit 226 or output from the global motion estimation unit. That is, the adaptive switch 228 is characterized to selectively output the first parameter set m2 or the second parameter set m3.

FIG. 10 shows a preferred embodiment depicting the operating process of the adaptive switch 228. Firstly, as show in step 420, the first parameter set m2 is tuned through the perspective transformation model to generate the second parameter set m3. Then, as shown in step 440, if the second parameter set m3 is greater than a preset value, or showing a tendency that can not converge, the second parameter set m3 is re-input to the perspective transformation subunit 226 to repeat the tuning step 420. The adaptive switch 228 may choose different preset number of iterations the perspective transformation subunit 226 repeats according to the complication of the image and the sort of the GME model. That is, the adaptive switch 228 may output the first parameter set m2 as the second parameter set m3 cannot converge after the preset number of iterations the perspective transformation subunit 226 repeats, or output the second parameter set m3. As a preferred embodiment, the preset number of iterations according to the present invention is 32. In addition, as the size control unit 270 discovers that the size of the present Sprite shows unreasonable expansion, it will ask the hybrid model GME unit 220 skip the perspective transformation steps and output the second parameter set m1 directly to maintain a good compressing efficiency.

Since the affine transformation model has an order lower than that of the perspective transformation model, the first parameter set m2 shows a smaller data amount than that of the second parameter set m3. That is, since the adaptive switch 228 within the hybrid model GME unit 220 is selectively output the first parameter set or the second parameter set, the total data amount of the present hybrid model GME unit 220 is greater than that of a GME unit using only affine transformation, but smaller than that of a GME unit using only perspective transformation.

In addition, since a perspective transformation subunit 226 is integrated to the rear end of the hierarchical affine transformation subunit for tuning the first parameter set m2, the hierarchical affine transformation subunit in the present invention does not have to use three-tier design. That is, two-tier or only one-tier may be enough for the hierarchical affine transformation subunit 224 disclosed in the present invention.

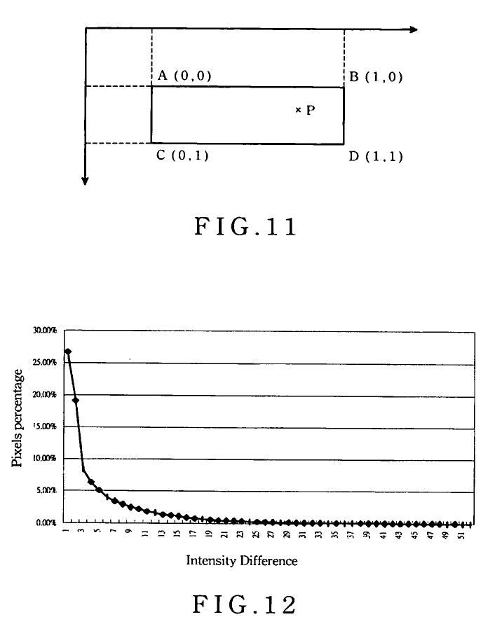

Moreover, the fast image warping unit 250 in the present invention uses the nearest neighborhood interpolation in replace of the bilinear interpolation used in the traditional Sprite generator shown in FIG. 2. FIG. 11 depicts the difference between the nearest neighborhood interpolation and the bilinear interpolation. As shown, the values of the points A(0,0), B(1,0), C(1,1), D(0,1) are 1, 2, 3, 4 respectively, and the coordinates of point P is (0.8,0.2). As the nearest neighborhood interpolation method is used, because the point B is the one closest to point P, the value of point P is assumed to be identical to point B. As the bilinear interpolation method is used, the value of point P is decided by integrating the values of the four point A,B,C,D and the distances between the point P and the four points A,B,C,D respectively. Thus, it is understood that the bilinear interpolation method provides a better estimation result but wastes more calculation time.

FIG. 12 shows an accounting chart depicting the strength error of the pixels within the Sprite generated by using nearest neighborhood interpolation method with respect to that generated by using bilinear interpolation method. A commonly used test sequence “Kiel-rev” is utilized for generating the result of the present accounting chart. As shown, more than 60% the pixels between the two Sprite show the strength error smaller than 5 bit, and more than 90% the pixels show the strength error smaller than 20 bit.

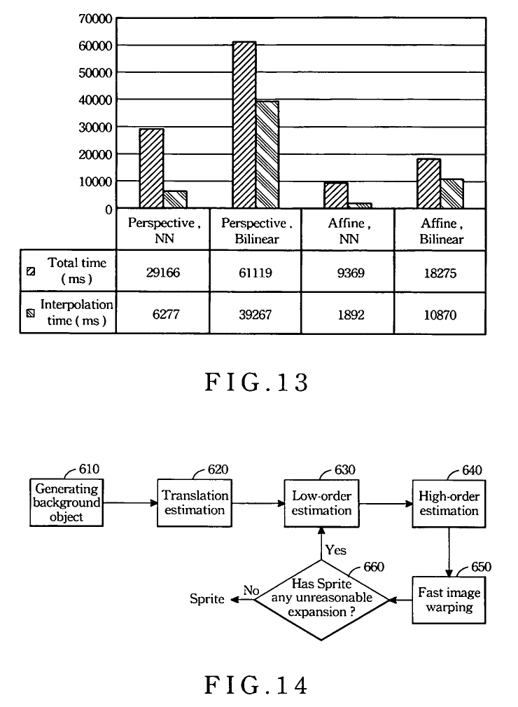

FIG. 13 shows a diagram depicting the calculation time needed for generating Sprite as different GME models and interpolation methods are used. A commonly used test sequence “Stefan” is utilized for generating the result of the chart. As shown, the nearest neighborhood interpolation method may significantly shorten the calculation time of the Sprite generator.

As mentioned, the hybrid model GME unit 220 uses hierarchical affine transformation subunit 224 and perspective transformation subunit 226, a higher order one and a lower order one, to proceed the motion estimation process. But the usage of the affine transformation subunit 224 and the perspective transformation subunit 226 is not a limit in the present invention. As a simpler image is provided, the affine transformation model may be replaced by a translation model, which compares the rough positional variation of the respected pixels, the perspective transformation model may be replaced by the affine transformation model, or even the translation estimation subunit 222 shown in FIG. 6 may be saved.

FIG. 14 shows a flowchart depicting a preferred embodiment for generating Sprite in accordance with the present invention. Firstly, as shown in step 610, given a video object plane (VOP) and removing the foreground objects of the VOP to output the background objects. Then, as shown in step 620, estimating the motivation and deformation of the background object with respect to the prior Sprite by using translation estimation to generate translation parameter m1. Afterward, as shown in step 630, estimating the motivation and deformation of the background object with respect to the prior Sprite by using a low-order estimation model with a preset order to generate a first parameter set. An affine transformation model may be a good choice for the first estimation model.

Afterward, as shown in step 640, tuning the first parameter set through matching the background object and the prior Sprite by using a high-order estimation model with a higher order to output the second parameter set. A perspective transformation model may be a good choice for the high-order estimation model. Then, as shown in step 650, warping the background object according to the second parameter set, and using nearest neighborhood interpolation method to recognize the location of the warped image on the prior Sprite, and so as to update the Sprite. It should be noted that the step of tuning the first parameter set must be repeated with a preset number of iteration or until the second parameter set converge. In addition, as the second parameter set cannot converge after the preset number of repeating of step 640, the first parameter set m2 is used to warp the background object.

Then, as shown in step 660, accessing the undated Sprite and the prior Sprite, and checking the size of the two Sprites to recognize whether any unreasonable expansion happens. If so, repeat the estimation step 630 to generate a new first parameter set, and tune the new first parameter set by using the steps 640 and 650 to generate a Sprite without such unreasonable expansion. If not, output the updated Sprite.

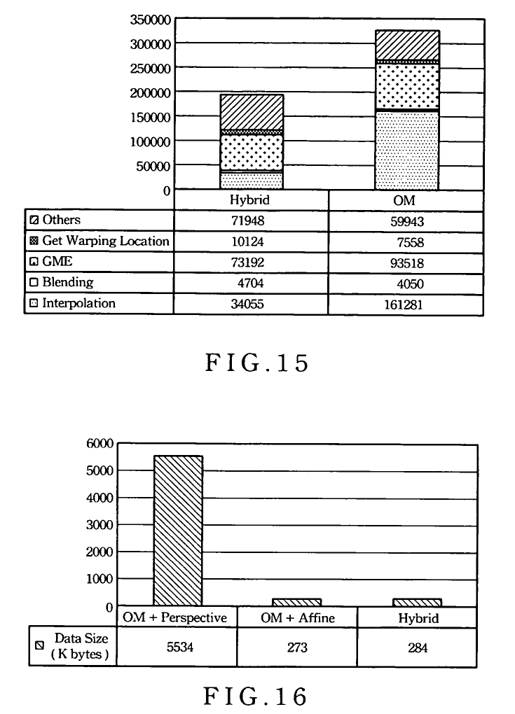

FIG. 15 shows a diagram depicting the calculation time needed for generate Sprite using the hybrid model Sprite generator 200 and the MPEG-4 OM Sprite generator mentioned in the prior art, respectively. A commonly used test sequence “Stefan_rev” is used in the present test. As shown, the calculation speed of the present hybrid model Sprite generator is much faster than the MPEG-4 OM Sprite generator.

FIG. 16 shows a diagram depicting the amount of data generated by using the hybrid model Sprite generator, the MPEG-4 OM Sprite generator with hierarchical affine transformation GME model or hierarchical perspective transformation GME model. A commonly used test sequence “Foreman” is used in the present test. As shown, the data amount generated by the present hybrid model Sprite generator is a little greater than that of the MPEG-4 OM hierarchical affine transformation Sprite generator, but much smaller than that of the MPEG-4 OM hierarchical perspective transformation Sprite generator. That is, for the hybrid model Sprite generator 200, only a small portion of the Sprite is formed through the second parameter set.

As mentioned, the present hybrid model Sprite generator 200 has the following advantages:

1. The hybrid model Sprite generator 200 uses nearest neighborhood interpolation method in replace of traditional bilinear interpolation, which needs only one-sixth the time of the interpolation step. In addition, as shown in FIGS. 4A and B, the interpolation step spends more than half the total consumption time to generate Sprite. Thus, by using the nearest neighborhood interpolation, the calculation time may be significant reduced and the operating efficiency may be promoted.

2. The present hybrid model Sprite generator 200 uses hybrid model global motion estimation (GME) unit 220 in replace of the traditional hierarchical affine (or perspective) transformation GME unit. With respect to the hierarchical affine transformation GME step, the hybrid model GME step wastes more time and generates more data, but presents a better visual quality especially in case of significant depth variation. With respect to the hierarchical perspective transformation GME, the hybrid model GME saves the calculation time and also the data amount. In addition, in the present hybrid model GME unit 220, the affine transformation step applied before the perspective transformation step may prevent local minimum from magnifying the errors.

3. The hybrid model Sprite generator 200 also has an adaptive switch 228 for selectively output the first parameter set m2 after affine transformation or the second parameter set m3 after perspective transformation. If the second parameter set m3 cannot converge, the adaptive switch 228 may output the first parameter set m2 to prevent the error magnification from affecting the accuracy of the Sprite. In addition, since the first parameter set m2 has less data amount than the second parameter set m3, the data amount generated by the present hybrid model Sprite generator 200 is less than that generated by the hierarchical perspective transformation GME unit to prevent some unneeded data transmission.

4. As the result of the Sprite generator has some unreasonable expansion or the loading of data transmitting is too heavy, the size control unit 270 may keep the best compressing efficiency by skipping perspective transformation or reset the calculation of GME.

While the embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. A hybrid model Sprite generator comprising:
an image region division unit for removing foreground objects within a video object plane (VOP) to provide background objects;
a frame memory for storing a prior Sprite;
a hybrid model global motion estimation (GME) unit comprising:
a first estimation subunit with a preset order, generating a first parameter set to estimate the motivation and deformation of the background objects with respect to the prior Sprite;
a second estimation subunit with a higher order, tuning the first parameter set by matching the background objects to the prior Sprite to generate a second parameter set; and
an adaptive switch, selectively outputting the first parameter set or the second parameter set;
a fast image warping unit for warping the background objects according to the output of the adaptive switch and recognize the location of the warped objects on the prior Sprite by using nearest neighborhood interpolation method to update the Sprite; and
a size control unit for checking the size of the warped objects and the prior Sprite, as the warped object needs a magnification over a preset fraction for matching the prior Sprite, the hybrid model GSM unit is reset.

2. The hybrid model Sprite generator according to claim 1, wherein the adaptive switch may output the first parameter set as the second parameter set cannot converge after a preset number of iterations the second estimation subunit repeats, or output the second parameter set.

3. The hybrid model Sprite generator according to claim 2, wherein the first estimation subunit is an affine transformation subunit, which compares the coordinate of pixels on the background objects and the coordinate of respected pixels on the prior Sprite to generate the first parameter set comprising a scale parameter, a shear parameter, and a rotation parameter.

4. The hybrid model Sprite generator according to claim 3, wherein the second estimation subunit is a perspective transformation subunit, which compares the coordinates of the pixels of the background objects and the respective coordinate space of the prior Sprite to generate the second parameter set including at least a perspective parameter representing the change of depth.

5. The hybrid model Sprite generator according to claim 4, wherein the perspective transformation subunit tunes the scale parameter, the shear parameter, and the rotation parameter, from the first parameter set, and the second parameter set comprises a tuned scale parameter, a tuned shear parameter, and a tuned rotation parameter.

6. The hybrid model Sprite generator according to claim 4, wherein the hybrid model GSM unit further comprises a translation estimation subunit for comparing the location of the pixels on the background objects and the location of the respected pixels on the prior Sprite to generate at least a translation parameter, and the affine transformation subunit accesses the translation parameter to generate the first parameter set comprising the scale parameter, the shear parameter, and the rotation parameter.

7. The hybrid model Sprite generator according to claim 6, wherein the perspective transformation subunit tunes the scale parameter, the shear parameter, the rotation parameter, and the translation parameter, and the second parameter set comprises a tuned scale parameter, a tuned shear parameter, a tuned rotation parameter, and a tuned translation parameter.

8. The hybrid model Sprite generator according to claim 2, wherein the preset number is 32.

9. The hybrid model Sprite generator according to claim 1, further comprising a blending unit for blending part of the foreground objects to the updated Sprite to improve the quality of the Sprite.

10. A hybrid model Sprite generator comprising:
an image region division unit for removing foreground objects within a video object plane (VOP) to provide background objects;
a frame memory for storing a prior Sprite;
a hybrid model global motion estimation (GME) unit comprising:
a translation estimation subunit for comparing the location of the pixels on the background objects and the location of the respected pixels on the prior Sprite to generate at least a translation parameter;
an affine transformation subunit for accessing the translation parameter and comparing the coordinate of pixels on the background objects and the coordinate of respected pixels on the prior Sprite to generate the first parameter set comprising a scale parameter, a shear parameter, and a rotation parameter thereby;
a perspective transformation subunit for accessing the first parameter set and comparing the coordinates of the pixels on the background objects and the respective coordinate space of the prior Sprite to generate the second parameter set comprising a perspective parameter representing the change of depth; and
an adaptive switch, which may output the first parameter set as the second parameter set cannot converge after a preset number of iterations the perspective transformation unit repeats, or output the second parameter set;
a fast image warping unit for warping the background objects according to the output of the adaptive switch and recognizing the location of the warped objects on the prior Sprite by using nearest neighborhood interpolation method to update the Sprite; and
a size control unit for checking the size of the warped objects and the prior Sprite, as the warped object needs a magnification over a preset fraction for matching the prior Sprite, the hybrid model GSM unit is reset.

11. The hybrid model Sprite generator according to claim 10, wherein the perspective transformation subunit tunes the scale parameter, the shear parameter, the rotation parameter, and the translation parameter, and the second parameter set comprises a tuned scale parameter, a tuned shear parameter, a tuned rotation parameter, and a tuned translation parameter.

12. The hybrid model Sprite generator according to claim 10, wherein the preset number is 32.

13. A method for generating Sprite comprising the steps of:
providing a video object plane (VOP);
removing foreground objects of the VOP to provide the background objects;
estimating the motivation and deformation of the background object with respect to a prior Sprite by using a first estimation model with a preset order to generate a first parameter set;
accessing the first parameter set and tuning the first parameter set through matching the background objects and the prior Sprite by using a second estimation model with a higher or equal order with respect to the preset order to generate a second parameter set;
warping the background object according to the first parameter set or the second parameter set to match the prior Sprite;
recognizing the location of the warped background object with respect to the prior Sprite by using nearest neighborhood interpolation method to update the prior Sprite; and
checking the updated Sprite and the prior Sprite, if some unreasonable magnification happened, repeat the estimating step for generating the first parameter set, if not, output the updated Sprite.

14. The method according to claim 13, wherein the second parameter set is used to warp the background object as the second parameter set is converged after a preset number of iterations of the estimating step using the second estimation model, or the first parameter set is used to warp the background object.

15. The method according to claim 14, wherein the step of estimating the motivation and deformation of the background objects using the first estimation model is to compare the coordinate of pixels on the background objects and the coordinate of relative pixels on the prior Sprite to generate the first parameter set including at least a scale parameter, a shear parameter, and a rotation parameter.

16. The method according to claim 15, wherein the estimating step using the second estimation model is to access the scale parameter, the shear parameter, the rotation parameter, and the translation parameter, and compare the coordinate of the pixels on the background objects and the respective coordinate space of the prior Sprite by using perspective transformation to generate the second parameter set including at least a perspective parameter representing the change of depth.

17. The method according to claim 16, wherein the step of estimating the movement and deformation of the background object uses affine transformation model, before the step further comprising a step of comparing the location of the pixels on the background objects and the location of the respective pixels on the prior Sprite to generate at least a translation parameter, and the estimating step using affine transformation model accesses the translation parameter to generate the first parameter set including at least the scale parameter, the shear parameter, and the rotation parameter.

18. The method according to claim 14 wherein the preset number is 32.
